(19) United States
(12) Patent Application Publication
(10) Pub. No.: US 2026/0170389 A1
(43) Pub. Date: Jun. 18, 2026

(54) TRUSTWORTHY REINFORCEMENT LEARNING

(71) Applicant: Nokia Technologies Oy, Espoo (FI)

(72) Inventors: Borislava GAJIC, Munich (DE); Sina KHATIBI, Munich (DE); Iris ADAM, Munich (DE); Abdelkader OUTTAGARTS, Massy (FR)

(21) Appl. No.: 18/707,792

(22) PCT Filed: Nov. 12, 2021
(86) PCT No.: PCT/EP2021/081477

§ 371 Date: May 6, 2024

(51) Int. Cl. G06N 20/00

(52) U.S. Cl. CPC G06N 20/00

(57) ABSTRACT

There are provided measures for trustworthy reinforcement learning. Such measures exemplarily comprise deriving, based on quality requirements in relation to reinforcement learning, a preliminary reinforcement learning plan, revising, based on data related to reinforcement learning on a network scenario, said preliminary reinforcement learning plan to a final reinforcement learning plan, and transmitting said final reinforcement learning plan to an artificial intelligence pipeline orchestrating entity.

### FIELD

Various example embodiments relate to trustworthy reinforcement learning. More specifically, various example embodiments exemplarily relate to measures (including methods, apparatuses and computer program products) for realizing trustworthy reinforcement learning.

### BACKGROUND

The present specification generally relates to reinforcement learning (RL), improvement of its effectiveness, as well as ensuring trustworthiness and in particular safety thereof.

Principally, in the RL framework, an agent observes the environment and chooses an action it deems appropriate to its observation of the given situation. The environment then sends a feedback signal called a reward to attach a value to the action.

An important characteristic of RL is that it can deal with environments that are dynamic, uncertain, and non-deterministic.

Therefore, RL is held to be a promising approach to be used in dynamic mobile networks where network conditions may frequently change.

The RL agent needs to explore unfamiliar states to learn from an environment, and the usual exploratory strategies rely on the agent occasionally choosing random actions.

However, learning in real-world safety-critical systems would require an exploratory algorithm to ensure safety.

Namely, as RL focuses on maximizing the long-term reward, it is likely to explore unsafe behaviors during the learning process.

There are two main approaches for ensuring RL safety:
1. Safe RL tries to learn a policy that maximizes the expected return, while also ensuring the satisfaction of some safety constraints. Known approaches to safe RL include reward-shaping and policy optimization with constraints. These model-free approaches do not guarantee safety during learning-safety is only approximately guaranteed after a sufficient learning period. The fundamental issue is that without a model, safety must be learned through environmental interactions, which means it may be violated during initial learning interactions.
2. Model-based approaches have utilized model predictive control to guarantee safety under system dynamics during learning. However, model-based approaches do not address the issue of exploration and performance optimization.

In order to automate network operations, a current trend is to implement self-organizing (or self-optimizing) network (SON) functions in an RL platform using learning-based agents, in which the feedback of the agents' actions is used to learn. Each SON function is specified through a set of thresholds that begins the execution of an associated SON algorithm.

RL-based mobility robustness optimization (MRO) is an example use-case of SON algorithms.

The MRO in cellular mobile communications is a well-known method to optimization of the mobility parameters to minimize mobility related failures and unnecessary handovers. The common approach in MRO algorithms is optimizing the cell individual offset (CIO) and time-to-trigger (TTT), i.e., key parameters in controlling the handover procedure initiation. The network can control the handover procedure between any cell pair in the network by defining different CIO and TTT values. Different CIO and TTT configurations are needed for mobile terminals with different speed. The faster the terminals are, the sooner the handover procedure must be started. This goal is achieved by either increasing the CIO (i.e., the offset between the measured signal power of serving cell and target cell) or decreasing the TTT (i.e., the interval during which the trigger requirement is fulfilled). In contrast, in the cell boundaries dominated by slow users, i.e., terminals, the handover procedures are started relatively later by choosing the lower values for the CIO or higher values for the TTT. Changing the CIOs rather than TTTs is the preferred approach.

MRO procedures can identify a bad handover decision and enable the related cell to correct them. To this end, Third Generation Partnership Project (3GPP) has introduced several messages via X2 interface, e.g., radio link failure (RLF) indication and handover report.

FIG. 9 shows a schematic diagram of an example of a system environment with interfaces and signaling variants according to example embodiments, and in particular illustrates example details of the trustworthy artificial intelligence framework (TAIF) in CANs underlying example embodiments.

Such TAIF for CANs may be provided to facilitate the definition, configuration, monitoring and measuring of artificial intelligence (AI)/machine learning (ML) model trustworthiness (i.e., fairness, explainability and robustness) for interoperable and multi-vendor environments. A service definition or the business/customer intent may include AI/ML trustworthiness requirements in addition to quality of service (QoS) requirements, and the TAIF is used to configure the requested AI/ML trustworthiness and to monitor and assure its fulfilment. The TAIF introduces two management functions, namely, a function entity named AI Trust Engine (one per management domain) and a function entity named AI Trust Manager (one per AI/ML pipeline). The TAIF further introduces six interfaces (named T1 to T6) that support interactions in the TAIF. According to the TAIF underlying example embodiments, the AI Trust Engine is center for managing AI trustworthiness related things in the network, whereas the AI Trust Managers are use case and often vendor specific, with knowledge of the AI use case and how it is implemented.

Furthermore, the TAIF underlying example embodiments introduces a concept of AI quality of trustworthiness (AI QoT) (as seen over the T1 interface in FIG. 9) to define AI/ML model trustworthiness in a unified way covering three factors, i.e., fairness, explainability and robustness, similar to how QoS is used for network performance. The factor robustness incorporates the aspects of safety as well. The TAIF underlying example embodiments generally does not consider RL aspects.

RL is a model-free approach based on the trial-and-error principle to find a near optimal solution to a problem. While ability to learn and adapt itself to dynamic environments make RL-based approaches very interesting in the networks, the potential negative impact to the network caused by the learning phases is still the main drawback.

In particular, the exploration phase performing trials and learning from errors may have an impact onto and thus might not be safe for the operational network. Furthermore, if such exploration phase is not trustworthy (does not comply with high fairness, explainability and robustness requirements) especially with respect to safety aspects, this may cause reluctance in applying such approach by network operators, despite its high-performance potential.

Thus, the trustworthiness aspects of the RL exploration phase is extremely important for acceptance and application of this approach in operational networks. The trustworthiness of RL needs to encompass the definition/planning configuration/setup of the exploration according to the trust requirements, as well as monitoring/measuring of trust fulfilment during the exploration phase.

Two types of RL explainability models are known, i.e. intrinsic vs. post-hoc. The explainability type depends on the time when the explanation is extracted/generated.

An intrinsic model is designed to be inherently interpretable or self-explanatory at the time of training by restricting the complexity of the model, e.g., decision trees are one example of such models with simple structure and can be easily understood. Although offering accurate explanations, the drawback of such models is that due to their simplicity their performance suffers, i.e, the performance of such models is not high.

On the other hand, post-hoc interpretability is achieved by analyzing the model after training by creating a second, simpler model, e.g. surrogate model, to provide explanations for the original model. Post-hoc models usually keep the performance of the original model unchanged, but it is harder to derive simple explanations following such approach. In addition, the explanations are available only after the training, i.e. after the RL exploration (with potential side effects/unsafe actions) has taken place.

Hence, a problem arises that inbuilt/inherent trustworthiness (including explainability) of RL should be available also during the exploration phase, thereby enabling a safe and robust exploration without impacting the model performance (i.e., with keeping high model performance).

Hence, there is a need to provide for trustworthy reinforcement learning.

### SUMMARY

Various example embodiments aim at addressing at least part of the above issues and/or problems and drawbacks.

Various aspects of example embodiments are set out in the appended claims.

According to an exemplary aspect, there is provided a method comprising deriving, based on quality requirements in relation to reinforcement learning, a preliminary reinforcement learning plan, revising, based on data related to reinforcement learning on a network scenario, said preliminary reinforcement learning plan to a final reinforcement learning plan, and transmitting said final reinforcement learning plan to an artificial intelligence pipeline orchestrating entity.

According to an exemplary aspect, there is provided a method comprising receiving a reinforcement learning configuration, receiving a final reinforcement learning plan, transmitting said reinforcement learning configuration to at least one of an artificial intelligence data source management entity, an artificial intelligence training management entity, and an artificial intelligence inference management entity, and receiving metrics in accordance with said reinforcement learning configuration from at least one of said artificial intelligence data source management entity, said artificial intelligence training management entity, and said artificial intelligence inference management entity.

According to an exemplary aspect, there is provided a method comprising receiving a final reinforcement learning plan, deciding on a degree of implementation of said final reinforcement learning plan, and implementing said final reinforcement learning plan based on said decided degree of implementation.

According to an exemplary aspect, there is provided an apparatus comprising deriving circuitry configured to derive, based on quality requirements in relation to reinforcement learning, a preliminary reinforcement learning plan, revising circuitry configured to revise, based on data related to reinforcement learning on a network scenario, said preliminary reinforcement learning plan to a final reinforcement learning plan, and transmitting circuitry configured to transmit said final reinforcement learning plan to an artificial intelligence pipeline orchestrating entity.

According to an exemplary aspect, there is provided an apparatus comprising receiving circuitry configured to receive a reinforcement learning configuration, and to receive a final reinforcement learning plan, and transmitting circuitry configured to transmit said reinforcement learning configuration to at least one of an artificial intelligence data source management entity, an artificial intelligence training management entity, and an artificial intelligence inference management entity, wherein said receiving circuitry is configured to receive metrics in accordance with said reinforcement learning configuration from at least one of said artificial intelligence data source management entity, said artificial intelligence training management entity, and said artificial intelligence inference management entity.

According to an exemplary aspect, there is provided an apparatus comprising receiving circuitry configured to receive a final reinforcement learning plan, deciding circuitry configured to decide on a degree of implementation of said final reinforcement learning plan, and implementing circuitry configured to implement said final reinforcement learning plan based on said decided degree of implementation.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform deriving, based on quality requirements in relation to reinforcement learning, a preliminary reinforcement learning plan, revising, based on data related to reinforcement learning on a network scenario, said preliminary reinforcement learning plan to a final reinforcement learning plan, and transmitting said final reinforcement learning plan to an artificial intelligence pipeline orchestrating entity.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a reinforcement learning configuration, receiving a final reinforcement learning plan, transmitting said reinforcement learning configuration to at least one of an artificial intelligence data source management entity, an artificial intelligence training management entity, and an artificial intelligence inference management entity, and receiving metrics in accordance with said reinforcement learning configuration from at least one of said artificial intelligence data source management entity, said artificial intelligence training management entity, and said artificial intelligence inference management entity.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a final reinforcement learning plan, deciding on a degree of implementation of said final reinforcement learning plan, and implementing said final reinforcement learning plan based on said decided degree of implementation.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient reinforcement learning which ensures satisfying trustworthiness requirements, in particular safety requirements, to thereby solve at least part of the problems and drawbacks identified in relation to the prior art.

By way of example embodiments, there is provided trustworthy reinforcement learning. More specifically, by way of example embodiments, there are provided measures and mechanisms for realizing trustworthy reinforcement learning.

Thus, improvement is achieved by methods, apparatuses and computer program products enabling/realizing trustworthy reinforcement learning.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a schematic diagram of a procedure according to example embodiments,

FIG. 7 is a schematic diagram of a procedure according to example embodiments,

FIG. 8 is a schematic diagram of a procedure according to example embodiments,

FIG. 9 shows a schematic diagram of an example of a system environment with interfaces and signaling variants according to example embodiments,

FIG. 10 shows a schematic diagram of signaling sequences according to example embodiments, and

FIG. 11 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) trustworthy reinforcement learning.

Namely, in brief, according to example embodiments, a method and apparatus for ensuring trustworthiness of RL exploration are provided. In particular, an RL Trust Enforcement Function entity is introduced, and corresponding services are defined, which derive an RL exploration plan and corresponding trust configuration in order to perform a safe and robust RL exploration phase. The defined services mentioned above may be services implying interactions between two entities. Namely, in an abstract construct, such service may be a service provided by a service provider and requested and consumed by a services consumer, such that corresponding interactions between service provider and services consumer are involved. A concrete example is given in the context of 3GPP SA5 service-oriented management architecture (e.g. 3GPP TS 28.533), where there is an interaction between a management service consumer and a management service provider. E.g., in this exemplary service-oriented management architecture, a management service consumer can request certain operations from management service providers such as on fault supervision or performance management services, etc.

The exploration plan according to example embodiments defines in detail all actions/operations that are allowed to be executed during the exploration phase.

According to example embodiments, the exploration plan may include:
a list of safety tasks/actions, which represent the smallest units of action that can be independently executed during the exploration phase without violating the safety and robustness requirements of the network as well as operators' policies,
a risk factor of the exploration plan, representing the expected degree of impact of the entire execution plan on the network/system which may be defined as maximum percentage of undesired change of relevant key performance indicators (KPI),
a risk interval of the exploration plan, representing the expected time interval of impact as the result of the entire execution plan, and/or
fall-back tasks/actions, along with thresholds/triggers to execute such fall-back tasks/actions; the fall-back tasks/actions represent a set of instructions/actions that shall be executed once the exploration plan causes an impact to the network which is beyond the expected one (risk factor and risk interval).

According to example embodiments, safety tasks/actions may include a safety task/action description, which provides instructions on how to carry on the action in a safe exploration (e.g. instruction on how to change certain parameters, trigger actions, etc.). According to example embodiments, such safety task/action description may include:
a task/action ID, which is a unique identifier,
parameter(s), which is/are a parameters set that the exploration action is going to change,
range(s), which define(s) the range which the aforementioned parameters are allowed to be changed,
target(s), which represent(s) the target component(s)/node(s) that the change is allowed to be implemented, e.g. a set of user equipments (UE), a set of gNBs, or a single virtual network function (VNF),
an execution time, which can be expressed as
   the time interval during which the execution of the task/action is allowed, or as
   the time instance in which the task/action shall be executed,
an execution frequency which represents the allowed frequency of executing the task/action,
an execution area/domain representing the area(s) or domain(s), over which the task/action is allowed to be executed such as a rural area, a network section, or a cloud infrastructure,
an execution network slice/service representing the network slice or group of slices over which the task is allowed to be executed,
a risk factor representing the expected degree of impact of the action on the network/system which may be defined as a maximum percentage of undesired change of relevant KPIs,
a risk interval representing the expected time interval of impact as the result of the task/action, and/or
an undo action, which represents the instruction on how to roll-back the given safety task/action (e.g. switch back to the parameters with no side-effects) along with the trigger/threshold indication on when to execute the undo action (e.g. when a certain KPI changes beyond specified threshold).

In order to derive the exploration plan, the RL Trust Enforcement Function entity according to example embodiments may take the following inputs into account:
use case details, i.e, the purpose for which the RL model will be used, e.g. mobility management use case, handover optimization, coverage and capacity optimization, etc.,
an objective/reward description, e.g., which KPIs shall be optimized and to what extend,
a context, i.e., environment in which the RL model will be used; the context may be described for example utilizing the following information, where each context may be mapped to a specific time instance:
   an area type/description, e.g., rural/urban/highway,
   an expected number of UEs,
   a mobility patterns of UEs,
   traffic patterns of UEs,
   service information, e.g., ultra-reliable low-latency communication (URLLC), enhanced mobile broadband (eMBB) services mapping to UEs,
   UE priority information, and/or
   a security status of UE and network, etc.
customer intent/operator policies which can be expressed by means of required QoS/QoT of the RL model, and/or
additional information and preferences from the network operator for exploration execution, such as:
   an indication on acceptable changes in the network which are not considered as safety violation, e.g., a specification of relevant KPIs along with their deltas which are acceptable for the operator,
   a time indication, e.g. a preferred start and stop of exploration, preferred time windows in which the exploration shall not be performed (e.g. avoiding rush hours), a preferred duration of the exploration/exploration effects, and/or
   a context indication such as:
      a space indication, e.g. a preferred area for performing exploration, or an area which shall not be subject of exploration,
      a UE indication, e.g. a preferred UE category, or a UE category which shall not be subject of exploration, and/or
      a service indication, e.g. preferred services for exploration, or an indication of services which shall not be subject of exploration.

According to example embodiments, the RL Trust Enforcement Function entity derives from the RL exploration plan the model explanations, fairness and robustness configuration (trustworthiness configuration) and metrics. The trustworthiness configuration can include explanation, fairness and robustness/safety configuration. For example, depending on the risk level of an exploration plan or the risk factor of the task, provision of the local explanation for every action of the plan or only the most “risky” actions of the plan can be requested/configured. Further, based on the operator preferences, the fairness configuration can be derived, e.g. treat all services/UEs equally/fair or not. In terms of robustness, the RL Trust Enforcement Function entity may instruct/configure that only selected tasks shall be executed, e.g. tasks for which the risk factor is below a certain threshold, etc. On the other hand, according to example embodiments, the RL Trust Enforcement Function entity configures which parameters need to be monitored/reported such that it that the trust can verify level/configuration has been fulfilled, e.g. received explanations for the most risky actions, whether the number of admitted UEs of different priorities matches the fairness configuration, performance metrics of the network (throughput, delay, etc.), to verify that the performed actions did not have negative impact on the network and/or did not violate the safety requirements/configurations.

According to example embodiments, further, the RL Trust Enforcement Function entity communicates the derived configurations and metrics to the related services and functions, e.g, the Pipeline Orchestrator entity and the Trust Manager entity in the TAIF underlying example embodiments.

According to example embodiments, further, the RL Trust Enforcement Function entity continuously monitors the safety of the execution plan, e.g. by monitoring the KPIs and acceptable deltas as indicated by the operator.

According to example embodiments, further, if needed, the RL Trust Enforcement Function entity updates the execution plan based on the monitored KPIs, e.g. adapts the tasks/actions or fall-back actions along with associated triggers/thresholds for their execution.

Example embodiments are specified below in more detail.

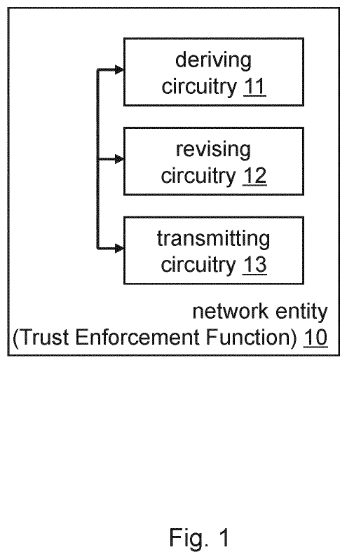

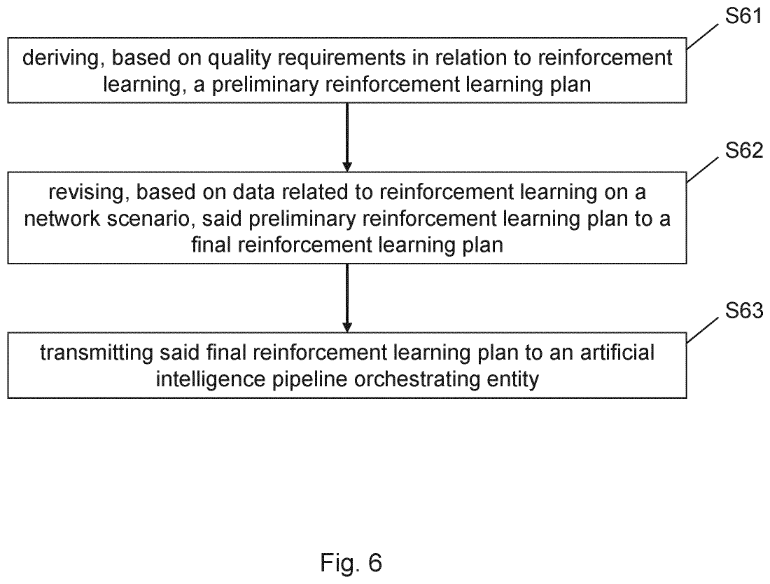

FIG. 1 is a block diagram illustrating an apparatus according to example embodiments. The apparatus may be a network node or entity 10 such as a Trust Enforcement Function entity (or element providing or hosting such functionality) comprising a deriving circuitry 11, a revising circuitry 12, and a transmitting circuitry 13. The deriving circuitry 11 derives, based on quality requirements in relation to reinforcement learning, a preliminary reinforcement learning plan. The revising circuitry 12 revises, based on data related to reinforcement learning on a network scenario, said preliminary reinforcement learning plan to a final reinforcement learning plan. The transmitting circuitry 13 transmits said final reinforcement learning plan to an artificial intelligence pipeline orchestrating entity. FIG. 6 is a schematic diagram of a procedure according to example embodiments. The apparatus according to FIG. 1 may perform the method of FIG. 6 but is not limited to this method. The method of FIG. 6 may be performed by the apparatus of FIG. 1 but is not limited to being performed by this apparatus.

As shown in FIG. 6, a procedure according to example embodiments comprises an operation of deriving (S61), based on quality requirements in relation to reinforcement learning, a preliminary reinforcement learning plan, an operation of revising (S62), based on data related to reinforcement learning on a network scenario, said preliminary reinforcement learning plan to a final reinforcement learning plan, and an operation of transmitting (S63) said final reinforcement learning plan to an artificial intelligence pipeline orchestrating entity.

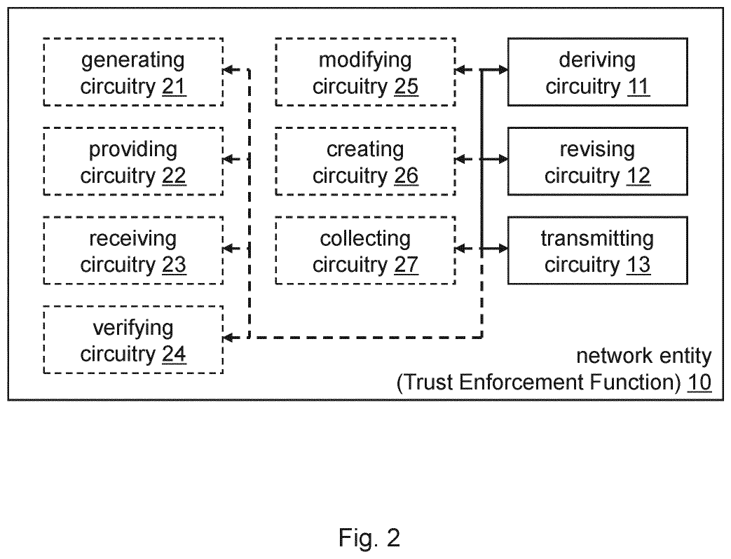

FIG. 2 is a block diagram illustrating an apparatus according to example embodiments. In particular, FIG. 2 illustrates a variation of the apparatus shown in FIG. 1. The apparatus according to FIG. 2 may thus further comprise a generating circuitry 21, a providing circuitry 22, a receiving circuitry 23, a verifying circuitry 24, a modifying circuitry 25, a creating circuitry 26, and/or a collecting circuitry 27.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary additional operations are given, which are inherently independent from each other as such. According to such variation, an exemplary method according to example embodiments may comprise an operation of generating, based on said final reinforcement learning plan, a reinforcement learning configuration.

According to further example embodiments, said reinforcement learning configuration includes a reinforcement learning monitoring configuration comprising at least one of information on parameters to be monitored, information on parameters to be reported, and information on a measurement period.

According to further example embodiments, said reinforcement learning configuration includes a reinforcement learning trustworthiness configuration comprising at least one of a reinforcement learning model explainability configuration, a reinforcement learning model fairness configuration, and a reinforcement learning model robustness configuration.

According to a variation of the procedure shown in FIG. 6, exemplary additional operations are given, which are inherently independent from each other as such. According to such variation, an exemplary method according to example embodiments may comprise an operation of providing said reinforcement learning configuration to an artificial intelligence trust management entity, and an operation of providing said final reinforcement learning plan to said artificial intelligence trust management entity.

According to a variation of the procedure shown in FIG. 6, exemplary additional operations are given, which are inherently independent from each other as such. According to such variation, an exemplary method according to example embodiments may comprise an operation of receiving, from said artificial intelligence trust management entity, metrics in accordance with said reinforcement learning configuration collected by at least one of an artificial intelligence data source management entity, an artificial intelligence training management entity, and an artificial intelligence inference management entity.

According to a variation of the procedure shown in FIG. 6, exemplary additional operations are given, which are inherently independent from each other as such. According to such variation, an exemplary method according to example embodiments may comprise an operation of transmitting said reinforcement learning configuration to at least one of an artificial intelligence data source management entity, an artificial intelligence training management entity, and an artificial intelligence inference management entity, and an operation of receiving metrics in accordance with said reinforcement learning configuration from at least one of said artificial intelligence data source management entity, said artificial intelligence training management entity, and said artificial intelligence inference management entity.

According to a variation of the procedure shown in FIG. 6, exemplary additional operations are given, which are inherently independent from each other as such. According to such variation, an exemplary method according to example embodiments may comprise an operation of verifying a level of safety of said reinforcement learning based on said metrics.

According to a variation of the procedure shown in FIG. 6, exemplary additional operations are given, which are inherently independent from each other as such. According to such variation, an exemplary method according to example embodiments may comprise an operation of modifying said final reinforcement learning plan based on said level of safety of said reinforcement learning.

According to a variation of the procedure shown in FIG. 6, exemplary additional operations are given, which are inherently independent from each other as such. According to such variation, an exemplary method according to example embodiments may comprise an operation of creating explanation information related to said final reinforcement learning plan.

According to a variation of the procedure shown in FIG. 6, exemplary additional operations are given, which are inherently independent from each other as such. According to such variation, an exemplary method according to example embodiments may comprise an operation of receiving said quality requirements in relation to said reinforcement learning.

According to further example embodiments, said quality requirements in relation to said reinforcement learning includes at least one of quality of service requirements in relation to said reinforcement learning and quality of trustworthiness requirements in relation to said reinforcement learning

According to a variation of the procedure shown in FIG. 6, exemplary additional operations are given, which are inherently independent from each other as such. According to such variation, an exemplary method according to example embodiments may comprise an operation of collecting said data related to reinforcement learning on said network scenario.

According to further example embodiments, said data related to reinforcement learning on said network scenario includes at least one of user equipment related information, network slice load related information, security related information, subscriber related information, network function state related information, sub-network related information, use-case related information, reinforcement learning objective related information, reinforcement learning context related information, and preference related information.

According to further example embodiments, said final reinforcement learning plan includes at least one of a list of actions allowed to be executed for said reinforcement learning, information on an expected impact of application of said final reinforcement learning plan on a network corresponding to said network scenario, information on an expected time interval of said expected impact, and information on measures to be taken upon exceedance of said expected impact and/or said expected time interval of said expected impact.

According to further example embodiments, said list of actions allowed to be executed for said reinforcement learning includes at least one action, and each of said at least one action is defined by at least one of information on one or more parameters to be changed by said action, information on one or more allowable change ranges corresponding to said one or more parameters to be changed by said action, information on one or more action targets, information on an action execution time, information on an action execution frequency, information on an action application realm, information on an expected impact of application of said action on said network, information on an expected time interval of said expected impact, and information on measures to be taken upon exceedance of said expected impact and/or said expected time interval of said expected impact.

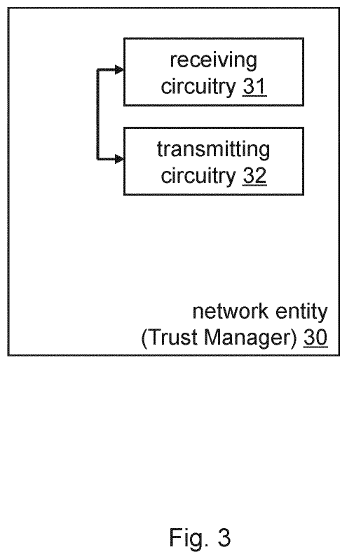

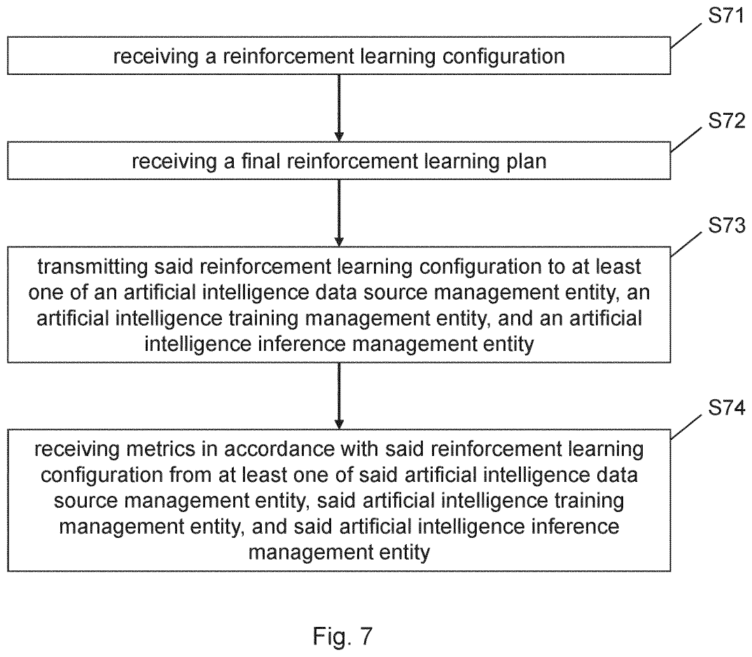

FIG. 3 is a block diagram illustrating an apparatus according to example embodiments. The apparatus may be a network node or entity 30 such as a Trust Manager entity (or element providing or hosting such functionality) comprising a receiving circuitry 31 and a transmitting circuitry 32. The receiving circuitry 31 receives a reinforcement learning configuration. The receiving circuitry 31 (or a further receiving circuitry) receives a final reinforcement learning plan. The transmitting circuitry 32 transmits said reinforcement learning configuration to at least one of an artificial intelligence data source management entity, an artificial intelligence training management entity, and an artificial intelligence inference management entity. The receiving circuitry 31 (or a further receiving circuitry) receives metrics in accordance with said reinforcement learning configuration from at least one of said artificial intelligence data source management entity, said artificial intelligence training management entity, and said artificial intelligence inference management entity. FIG. 7 is a schematic diagram of a procedure according to example embodiments. The apparatus according to FIG. 3 may perform the method of FIG. 7 but is not limited to this method. The method of FIG. 7 may be performed by the apparatus of FIG. 3 but is not limited to being performed by this apparatus.

As shown in FIG. 7, a procedure according to example embodiments comprises an operation of receiving (S71) a reinforcement learning configuration, an operation of receiving (S72) a final reinforcement learning plan, an operation of transmitting (S73) said reinforcement learning configuration to at least one of an artificial intelligence data source management entity, an artificial intelligence training management entity, and an artificial intelligence inference management entity, and an operation of receiving (S74) metrics in accordance with said reinforcement learning configuration from at least one of said artificial intelligence data source management entity, said artificial intelligence training management entity, and said artificial intelligence inference management entity.

In an embodiment at least some of the functionalities of the apparatus shown in FIG. 3 may be shared between two physically separate devices forming one operational entity. Therefore, the apparatus may be seen to depict the operational entity comprising one or more physically separate devices for executing at least some of the described processes.

According to further example embodiments, said reinforcement learning configuration includes a reinforcement learning monitoring configuration comprising at least one of information on parameters to be monitored, information on parameters to be reported, and information on a measurement period.

According to further example embodiments, said reinforcement learning configuration includes a reinforcement learning trustworthiness configuration comprising at least one of a reinforcement learning model explainability configuration, a reinforcement learning model fairness configuration, and a reinforcement learning model robustness configuration.

According to further example embodiments, said final reinforcement learning plan includes at least one of a list of actions allowed to be executed for reinforcement learning, information on an expected impact of application of said final reinforcement learning plan on a network corresponding to said network scenario, information on an expected time interval of said expected impact, and information on measures to be taken upon exceedance of said expected impact and/or said expected time interval of said expected impact.

According to further example embodiments, said list of actions allowed to be executed for said reinforcement learning includes at least one action, and each of said at least one action is defined by at least one of information on one or more parameters to be changed by said action, information on one or more allowable change ranges corresponding to said one or more parameters to be changed by said action, information on one or more action targets, information on an action execution time, information on an action execution frequency, information on an action application realm, information on an expected impact of application of said action on said network, information on an expected time interval of said expected impact, and information on measures to be taken upon exceedance of said expected impact and/or said expected time interval of said expected impact.

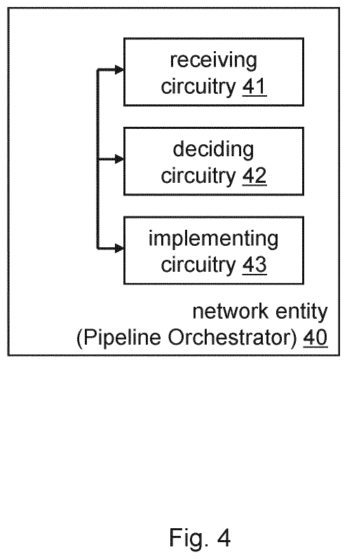

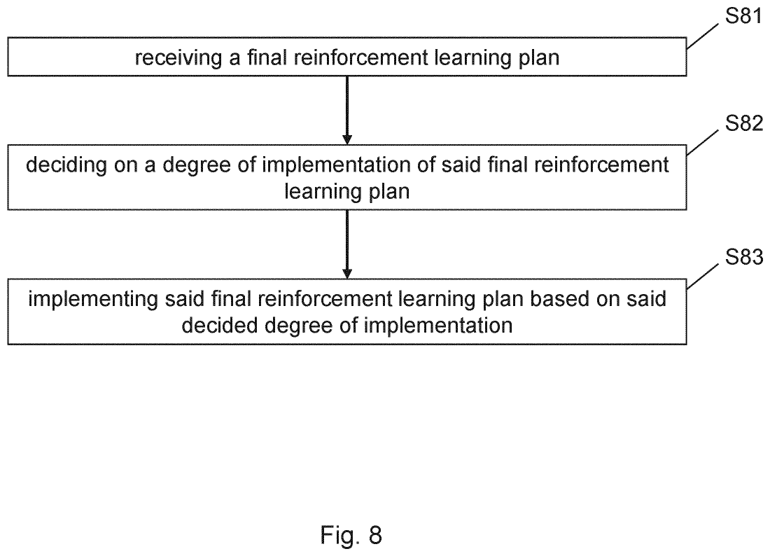

FIG. 4 is a block diagram illustrating an apparatus according to example embodiments. The apparatus may be a network node or entity 40 such as a Pipeline Orchestrator entity (or element providing or hosting such functionality) comprising a receiving circuitry 41, a deciding circuitry 42, and an implementing circuitry 43. The receiving circuitry 41 receives a final reinforcement learning plan. The deciding circuitry 42 decides on a degree of implementation of said final reinforcement learning plan. The implementing circuitry 43 implements said final reinforcement learning plan based on said decided degree of implementation. FIG. 8 is a schematic diagram of a procedure according to example embodiments. The apparatus according to FIG. 4 may perform the method of FIG. 8 but is not limited to this method. The method of FIG. 8 may be performed by the apparatus of FIG. 4 but is not limited to being performed by this apparatus.

As shown in FIG. 8, a procedure according to example embodiments comprises an operation of receiving (S81) a final reinforcement learning plan, an operation of deciding (S82) on a degree of implementation of said final reinforcement learning plan, and an operation of implementing (S83) said final reinforcement learning plan based on said decided degree of implementation.

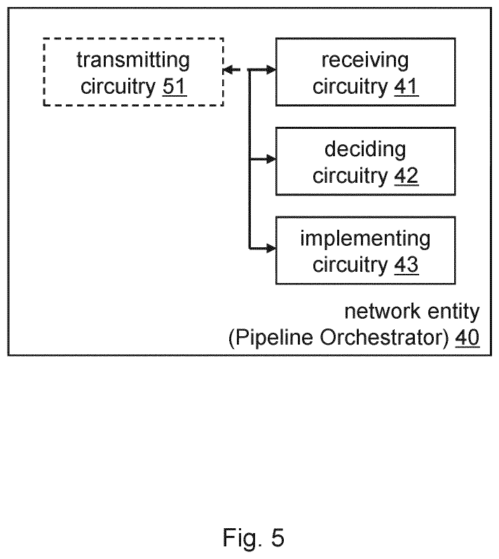

FIG. 5 is a block diagram illustrating an apparatus according to example embodiments. In particular, FIG. 5 illustrates a variation of the apparatus shown in FIG. 4. The apparatus according to FIG. 5 may thus further comprise a transmitting circuitry 51.

In an embodiment at least some of the functionalities of the apparatus shown in FIG. 4 (or 5) may be shared between two physically separate devices forming one operational entity. Therefore, the apparatus may be seen to depict the operational entity comprising one or more physically separate devices for executing at least some of the described processes.

According to further example embodiments, said deciding (i.e., said deciding operation (S82)) is based on current network conditions.

According to a variation of the procedure shown in FIG. 6, exemplary additional operations are given, which are inherently independent from each other as such. According to such variation, an exemplary method according to example embodiments may comprise an operation of transmitting information on said degree of implementation.

According to further example embodiments, said final reinforcement learning plan includes at least one of a list of actions allowed to be executed for reinforcement learning, information on an expected impact of application of said final reinforcement learning plan on a network corresponding to said network scenario, information on an expected time interval of said expected impact, and information on measures to be taken upon exceedance of said expected impact and/or said expected time interval of said expected impact.

According to further example embodiments, said list of actions allowed to be executed for said reinforcement learning includes at least one action, and each of said at least one action is defined by at least one of information on one or more parameters to be changed by said action, information on one or more allowable change ranges corresponding to said one or more parameters to be changed by said action, information on one or more action targets, information on an action execution time, information on an action execution frequency, information on an action application realm, information on an expected impact of application of said action on said network, information on an expected time interval of said expected impact, and information on measures to be taken upon exceedance of said expected impact and/or said expected time interval of said expected impact.

Example embodiments outlined and specified above are explained below in more specific terms.

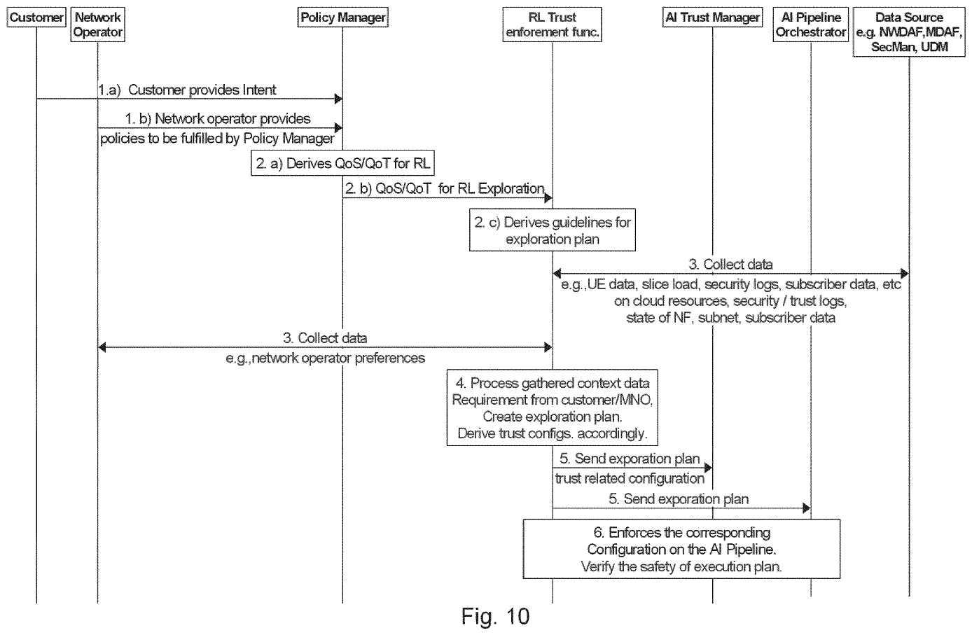

FIG. 10 shows a schematic diagram of signaling sequences according to example embodiments, and in particular illustrates an exemplary high-level RL Trust Enforcement workflow according to example embodiments.

According to example embodiments, the RL Trust Enforcement Function (entity) is provided as a standalone entity, as illustrated in FIG. 10 also in order to illustrate more clearly its functionality. However, according to alternative example embodiments, the RL Trust Enforcement Function (entity) is provided as part of other entities, e.g., as part of an AI Trust Manager entity (of the TAIF underlying example embodiments), and relies on already existing interfaces of the TAIF (underlying example embodiments) for data exchange. In addition, it is noted that, while explained partly or in full with reference to the TAIF (underlying example embodiments), according to example embodiments, the RL Trust Enforcement Function (entity) is applicable to other frameworks as well, and may alternatively be provided e.g. as NWDAF service extensions, etc.

In a step 1a of FIG. 10, a customer requests for a service via an intent request towards a Policy Manager (entity) (of the TAIF underlying example embodiments).

In addition, in a step 1b of FIG. 10, the Network Operator provides the policies that need to be fulfilled to the Policy Manager (entity).

In a step 2a of FIG. 10, the Policy Manager (entity) translates the received customer intent to a RL QoS (e.g. accuracy of the model) as well as to a required RL QoT (explainability, fairness, robustness/safety).

In a step 2b of FIG. 10, the Policy Manager (entity) provides the RL QoS and/or the RL QoT to the RL Trust Enforcement Function/Service (entity) according to example embodiments. As mentioned above, according to example embodiments, the RL Trust Enforcement Function/Service (entity) may be part of another management entity (e.g. Trust Engine, AI Trust Manager), or may be a standalone entity.

In a step 2c of FIG. 10, according to example embodiments, based on such input, the RL Trust Enforcement Function (entity) derives execution plan guidelines which will be verified and adjusted based on the further information to be collected.

In a step 3 of FIG. 10, according to example embodiments, the RL Trust Enforcement Function (entity) collects the needed data in order to derive the actual execution plan. According to example embodiments, the data is collected from different sources, e.g. network data analytics function (NWDAF), management data analytics function (MDAF), security manager (SecMan), unified data management (UDM), etc. In addition, according to example embodiments, the RL Trust Enforcement Function (entity) collects input from the network operator on its preferences.

In a step 4 of FIG. 10, according to example embodiments, the RL Trust Enforcement Function (entity) processes all received information, i.e. information on required RL QoT, use case and context information, reward information, and further additional information such as operator preferences. Based on the processed information, the RL Trust Enforcement Function (entity) derives the actual execution plan (also mentioned herein as “final reinforcement learning plan”) as well as respective trust configurations (also mentioned herein as “reinforcement learning configuration”, which may include a monitoring configuration and/or a trustworthiness configuration as explained below).

In a step 5 of FIG. 10, according to example embodiments, the RL Trust Enforcement Function (entity) informs the AI Trust Manager (entity) regarding the trust related configurations for the derived execution plan. According to example embodiments, this includes information on which KPIs shall be measured/monitored and reported back to the AI Trust Manager (entity) in order to determine the actual risk factor and risk interval, and in which time period, respectively. In addition, according to example embodiments, the RL Trust Enforcement Function (entity) informs an AI Pipeline Orchestrator (entity) (of the TAIF underlying example embodiments) regarding the execution plan to be performed, i.e, which safety tasks/actions shall be executed, and how.

In a step 6 of FIG. 10, according to example embodiments, the AI Trust Manager (entity) and the AI Pipeline Orchestrator (entity) enforce the received instructions in the RL Pipeline (of the TAIF underlying example embodiments). For example, the AI Trust Manager (entity) may provide the related configuration to AI Data Source Manager (entity), AI Training Manager (entity), and AI Inference Manager (entity) (respectively of the TAIF underlying example embodiments) via TAIF interfaces (e.g. interfaces T3, T4, T5) and collects relevant metrics. Further, in this example, the AI Pipeline Orchestrator (entity) may realize the execution plan (completely or only selected tasks) based on the current network status, e.g. with respect to resource, load condition, etc. The AI Pipeline Orchestrator (entity) may provide the information on actually executed tasks/execution plan to the RL Trust Enforcement Function (entity)/AI Trust Manager (entity) such that the corresponding monitoring/verification of the execution plan safety can be performed by the RL Trust Enforcement Function (entity) (or the AI Trust Manager (entity) if providing or hosting the functionality of the RL Trust Enforcement Function (entity) according to example embodiments).

A specific example is given below for the above-introduced particular use case “RL mobility robustness optimization (MRO)”.

In this specific example, in step 1a of FIG. 10, the provided intent is “Minimize the failures in all cell boundaries”, which is a typical intention in RL MRO.

Further, in this specific example, in step 1b of FIG. 10, the related network operator's policies are summarized as:
No increase of service interruption for URLLC slice users,
No more than 1% per minutes increase of service interruption for eMBB and internet of things (IoT) slice,
No increase of energy consumption for URLLC and IoT slices users, and
No more than 5% per minutes increase of network load and no increase of load during busy hour (06:00-20:00).

Further, in this specific example, in step 2a of FIG. 10, the Policy Manager (entity) translates the intention and policies into QoS/QoT.

Further, in this specific example, in step 2b of FIG. 10, the Policy Manager (entity) signals the QoS/QoT to the RL Trust Enforcement Function (entity).

Further, in this specific example, in step 2c of FIG. 10, the RL Trust Enforcement Function (entity) derives the guidelines for an RL exploration plan matching the QoS/QoT.

In this specific example, the exploration plan guideline is indicated as follows:
Use the active eMBB users for exploration during the resting time (21:00-05:00),
Use the idle eMBB users for exploration during all day,
Limit the increase network signaling as the result of exploration to less than 1%,
Limit the risk to medium level (<70%),
Task 1: Change of CIO for IDLE users (consider different slices, e.g. eMBB, different UE categories, time, scope, etc.), and
Task 2: Change of CIO for ACTIVE users (consider different slices, e.g. eMBB, different UE categories, time, scope, etc.).

The exploration plan guidelines are used to derive the actual exploration plan based on further information collected in steps 3 and 4.

Namely, in this specific example, in step 3 of FIG. 10, data is collected from operations, administration and maintenance (OAM) and/or near-RT RIC (RT: real time, RIC: RAN intelligent controller, RAN: radio access network) and/or gNB, as well as operator non-RT RIC. As an example, network operator preferences indicated that the shorter time window shall be used for exploration with active users (00:00-04:00). This information shall be used for adjusting the exploration plan with respect to initial exploration plan guidelines.

Further, in this specific example, in step 4 of FIG. 10, the collected data are processed, and an MRO exploration plan is created (information elements of an exploration plan are defined below).

In this specific example, the requested exploration plan for RL MRO is as follows:
Task 1:
   ID: 001,
   Parameter: CIO Cell Pair (x-y),
   Range: [−5, +5] dB,
   Target: Idle UEs of eMBB slice,
   Execution Time:
      The time Interval: All Day,
      The time Instance: During Idle time of UE,
   Execution Frequency: 0.2 [execution/min] (i.e. once every 5 minutes),
   Execution Area: Cell x and Cell y,
   Execution Network Slice: eMBB,
   Risk Factor: Low (<10%),
   Risk Interval: 1 s after each execution,
   Undo action: Nothing/Send RRC Release Message,
Task 2:
   ID: 002,
   Parameter: CIO Cell Pair (x-y),
   Range: [−1, +1] dB,
   Target: Active UEs of eMBB slice,
   Execution Time:
      The time Interval: 00:00-04:00,
      The time Instance: When delay sensitive service are not running (e.g. only running traffic is QCI 6-9—traffic classes ID related to video streaming),
   Execution Frequency: 0.1 [execution/min] (i.e. once every 10 minutes),
   Execution Area: Cell x and Cell y,
   Execution Network Slice: eMBB,
   Risk Factor: Medium (<30%),
   Risk Interval: 5 s (after each execution),
   Undo action: Send Original CIO with RRC reconfigure,
Risk factor of exploration plan: Low (<10%),
Risk Interval of exploration plan: 00:00-04:00 (with respect to Task 2),
Fall-back tasks/action: Reset CIO to initial value and update all UEs in domain (using RRCReconfigMsg).

Further, in this specific example, in step 5 of FIG. 10, the exploration plan is sent to the AI Trust Manager (entity) and the AI Pipeline Orchestrator (entity).

Further, in this specific example, in step 6 of FIG. 10, the exploration plan is enforced on the RL MRO agent (entity):
Here, the AI Pipeline Orchestrator (entity) will finally decide on how to execute the exploration plan based on further information, e.g. current network conditions, for example in terms of resources (including security status), knowledge collected from previous RL plan executions, etc. This may involve choosing only a sub-set of tasks to execute. This information can be sent to the RL Trust Enforcement Function (entity)/AI Trust Manager (entity), such that the recipient is aware of actually executed tasks.
Further, the AI Trust Manager (entity)/RL Trust Enforcement Function (entity) monitors the related KPIs, e.g. handover success rate and handover failure rate, verifies the level of actual safety after the execution of tasks, creates according explanations, and (if needed) updates the tasks/plans accordingly.

Explanation information related to the requested actual exploration plan (i.e., final reinforcement learning plan) are created. In the execution plan described for optimization of handover decisions above, Task 1 operates on idle users and it is of lower risk than Task 2, which operates on active users. The according explanation configuration might be that for Task 1 some aggregate explanation is enough, e.g. after executing it for X times, whereas for Task 2, which is of higher risk, for each execution of the task the explanation shall be created. So, the Trust Enforcement Function (entity) can create an explanation for Task 1, e.g. “performed x times CIO change for idle users in range [a, b] dB during time [c, d]”, and/or for execution of each Task 2, e.g. “performed CIO change of x dB, at time y, the active user had non-delay-critical service on”.

According to example embodiments, the exploration plan is sent towards the AI Trust Manager (entity) and the AI Pipeline Orchestrator (entity) via defined interfaces. According to example embodiments, the exploration plan may have the following information elements listed in the table below.

| | Mandatory/ | |
|---|---|---|
| Parameter | Optional | Description |
| Domain Scope or | Mandatory | Which domain (e.g., RAN, |
| S-NSSAI | | transport, core) or slice the |
| | | exploration plan is valid for S- |
| | | NSSAI as per TS 23.501/23.502 |
| CNF ID | Mandatory | Which domain/slice-specific AI |
| | | pipeline the TAI exploration plan is |
| | | valid for |
| UE ID or group | Optional | Which UE or group of UEs the |
| of UEs | | exploration plan is valid for |
| Task ID (e.g., | Mandatory | Unique identifier of action, which |
| 1 . . . N) | | can be executed in RL exploration |
| | | without violating the safety |
| Parameter type | Mandatory | Unique identifier of parameter that |
| (e.g., 1 . . . N) | | exploration action is going to |
| | | change |
| Range | Optional | Allowed range of the parameter |
| | | (depends on parameter type) |
| Target | Mandatory | Unique identifier of network |
| | | component or set of components in |
| | | domain/slice |
| Execution Time | Mandatory | Time interval for execution the task |
| | | (e.g. minutes) or time instance to |
| | | start the execution (e.g., given in |
| | | text form) |
| Execution | Optional | Allowed frequency of executing the |
| Frequency | | task (e.g. period given in seconds) |
| Execution Area | Mandatory | The area, domain, slice over which |
| | | the task can be executed |
| Risk factor | Mandatory | Degree of impact of task (e.g., |
| | | maximum percentage of change of |
| | | relevant KPIs) |
| Risk interval | Mandatory | Expected time interval after task |
| | | execution in which there is |
| | | impact/effect to network as the |
| | | result of the action (e.g. expressed |
| | | in seconds) |
| Roll-back action | Optional | Instruction on how to mitigate the |
| | | safety violation of the task (e.g. in |
| | | text form or the ID of the task to be |
| | | executed as roll-back) |
| Exploration Plan | Mandatory | Degree of impact (e.g. percentage |
| Risk-factor | | of change of relevant KPIs) |
| Exploration Plan | Optional | Expected time interval after |
| Risk-interval | | execution plan start in which there |
| | | is impact/effect to network as the |
| | | result of the execution plan (e.g. |
| | | expressed in hours) |
| Exploration Plan | Optional | Instruction on how to mitigate |
| Fall-Back | | safety violations (e.g. in text form |
| | | or the ID of the task to be executed |
| | | as roll-back) |

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e, the expression “unit configured to” is construed to be equivalent to an expression such as “means for”).

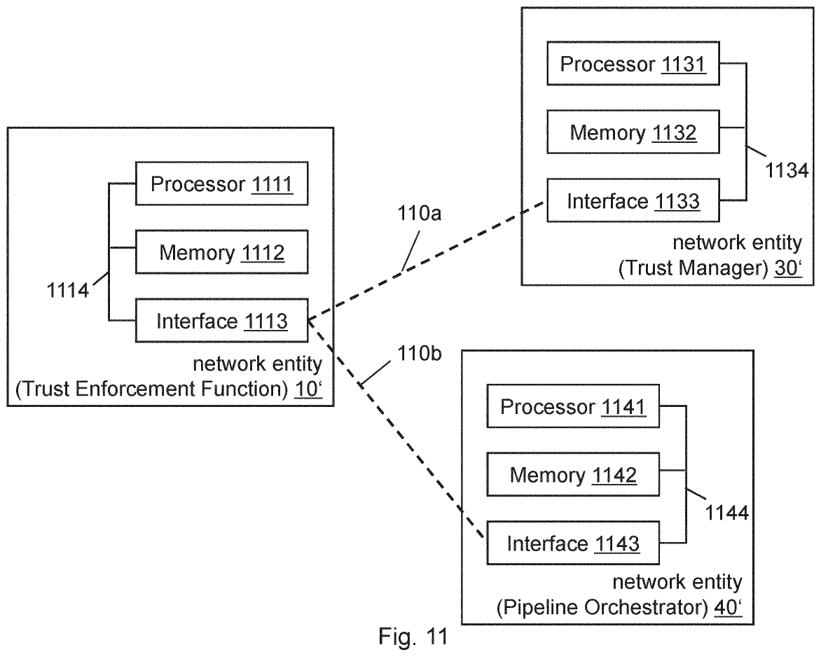

In FIG. 11, an alternative illustration of apparatuses according to example embodiments is depicted. As indicated in FIG. 11, according to example embodiments, the apparatus (network entity) 10′ (corresponding to the network entity 10) comprises a processor 1111, a memory 1112 and an interface 1113, which are connected by a bus 1114 or the like. Further, according to example embodiments, the apparatus (network entity) 30′ (corresponding to the network entity 30) comprises a processor 1131, a memory 1132 and an interface 1133, which are connected by a bus 1134 or the like. Further, according to example embodiments, the apparatus (network entity) 40′ (corresponding to the network entity 40) comprises a processor 1141, a memory 1142 and an interface 1143, which are connected by a bus 1144 or the like. The apparatuses may be connected via links 110a, 110b, respectively.

The processor 1111/1131/1141 and/or the interface 1113/1133/1143 may also include a modem or the like to facilitate communication over a (hardwire or wireless) link, respectively. The interface 1113/1133/1143 may include a suitable transceiver coupled to one or more antennas or communication means for (hardwire or wireless) communications with the linked or connected device(s), respectively. The interface 1113/1133/1143 is generally configured to communicate with at least one other apparatus, i.e. the interface thereof.

The memory 1112/1132/1142 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e, the expression “processor configured to [cause the apparatus to] perform xxx-ing” is construed to be equivalent to an expression such as “means for xxx-ing”).

According to example embodiments, an apparatus representing the network node or entity 10 comprises at least one processor 1111, at least one memory 1112 including computer program code, and at least one interface 1113 configured for communication with at least another apparatus. The processor (i.e, the at least one processor 1111, with the at least one memory 1112 and the computer program code) is configured to perform deriving, based on quality requirements in relation to reinforcement learning, a preliminary reinforcement learning plan (thus the apparatus comprising corresponding means for deriving), to perform revising, based on data related to reinforcement learning on a network scenario, said preliminary reinforcement learning plan to a final reinforcement learning plan (thus the apparatus comprising corresponding means for revising), and to perform transmitting said final reinforcement learning plan to an artificial intelligence pipeline orchestrating entity (thus the apparatus comprising corresponding means for transmitting).

According to example embodiments, an apparatus representing the network node or entity 30 comprises at least one processor 1131, at least one memory 1132 including computer program code, and at least one interface 1133 configured for communication with at least another apparatus. The processor (i.e, the at least one processor 1131, with the at least one memory 1132 and the computer program code) is configured to perform receiving a reinforcement learning configuration (thus the apparatus comprising corresponding means for receiving), to perform receiving a final reinforcement learning plan, to perform transmitting said reinforcement learning configuration to at least one of an artificial intelligence data source management entity, an artificial intelligence training management entity, and an artificial intelligence inference management entity (thus the apparatus comprising corresponding means for transmitting), and to perform receiving metrics in accordance with said reinforcement learning configuration from at least one of said artificial intelligence data source management entity, said artificial intelligence training management entity, and said artificial intelligence inference management entity.

According to example embodiments, an apparatus representing the network node or entity 40 comprises at least one processor 1141, at least one memory 1142 including computer program code, and at least one interface 1143 configured for communication with at least another apparatus. The processor (i.e, the at least one processor 1141, with the at least one memory 1142 and the computer program code) is configured to perform receiving a final reinforcement learning plan (thus the apparatus comprising corresponding means for receiving), to perform deciding on a degree of implementation of said final reinforcement learning plan (thus the apparatus comprising corresponding means for deciding), and to perform implementing said final reinforcement learning plan based on said decided degree of implementation (thus the apparatus comprising corresponding means for implementing).

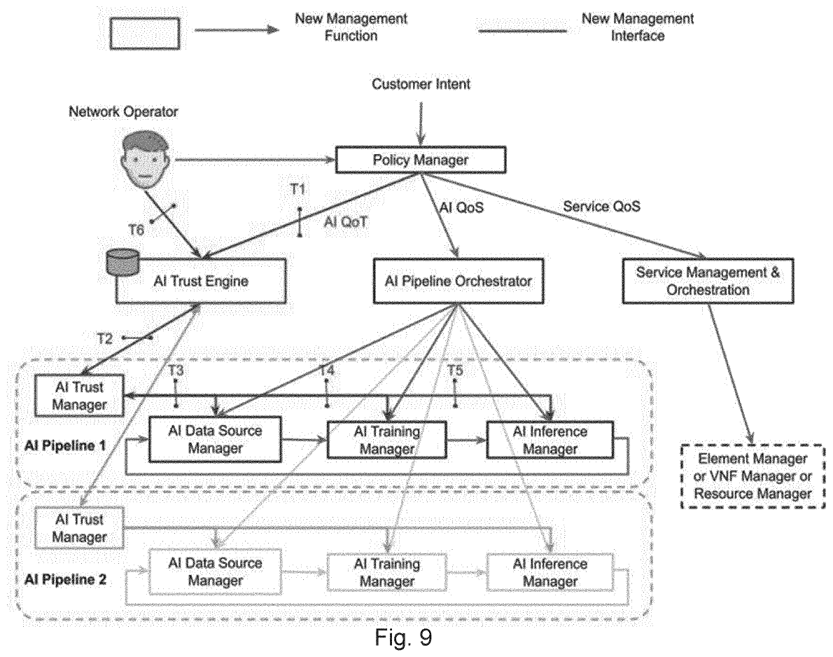

For further details regarding the operability/functionality of the individual apparatuses, reference is made to the above description in connection with any one of FIGS. 1 to 10, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g, the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for trustworthy reinforcement learning. Such measures exemplarily comprise deriving, based on quality requirements in relation to reinforcement learning, a preliminary reinforcement learning plan, revising, based on data related to reinforcement learning on a network scenario, said preliminary reinforcement learning plan to a final reinforcement learning plan, and transmitting said final reinforcement learning plan to an artificial intelligence pipeline orchestrating entity.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

List of acronyms and abbreviations

| | |
|---|---|
| 3GPP | Third Generation Partnership Project |
| AI | artificial intelligence |
| AI | QoT AI quality of trustworthiness |
| CIO | cell individual offset |
| eMBB | enhanced mobile broadband |
| IoT | internet of things |
| KPI | key performance indicator |
| MDAF | management data analytics function |
| ML | machine learning |
| MRO | mobility robustness optimization |
| near-RT | near-real-time |
| non-RT | non-real-time |
| NWDAF | network data analytics function |
| OAM | operations, administration and maintenance |
| QoS | quality of service |
| RAN | radio access network |
| RIC | RAN intelligent controller |
| RL | reinforcement learning |
| RLF | radio link failure |
| SecMan | security manager |
| SON | self-organizing network, self-optimizing network |
| TAIF | trustworthy artificial intelligence framework |
| TTT | time-to-trigger |
| UDM | unified data management |
| UE | user equipment |
| URLLC | ultra-reliable low-latency communication |
| VNF | virtual network function |

1-80. (canceled)

81. An apparatus comprising
at least one processor,
at least one memory including computer program code, and
at least one interface configured for communication with at least another apparatus,
the at least one processor, with the at least one memory and the computer program code, being configured to cause the apparatus to perform:
deriving, based on quality requirements in relation to reinforcement learning, a preliminary reinforcement learning plan,
revising, based on data related to reinforcement learning on a network scenario, said preliminary reinforcement learning plan to a final reinforcement learning plan, and
transmitting said final reinforcement learning plan to an artificial intelligence pipeline orchestrating entity.

82. The apparatus according to claim 81, wherein
the at least one processor, with the at least one memory and the computer program code, being configured to cause the apparatus to perform:
generating, based on said final reinforcement learning plan, a reinforcement learning configuration.

83. The apparatus according to claim 82, wherein
said reinforcement learning configuration includes a reinforcement learning monitoring configuration comprising at least one of information on parameters to be monitored, information on parameters to be reported, and information on a measurement period.

84. The apparatus according to claim 82, wherein
said reinforcement learning configuration includes a reinforcement learning trustworthiness configuration comprising at least one of a reinforcement learning model explainability configuration, a reinforcement learning model fairness configuration, and a reinforcement learning model robustness configuration.

85. The apparatus according to claim 82, wherein
the at least one processor, with the at least one memory and the computer program code, being configured to cause the apparatus to perform:
providing said reinforcement learning configuration to an artificial intelligence trust management entity, and
providing said final reinforcement learning plan to said artificial intelligence trust management entity.

86. The apparatus according to claim 85, wherein
the at least one processor, with the at least one memory and the computer program code, being configured to cause the apparatus to perform:
receiving, from said artificial intelligence trust management entity, metrics in accordance with said reinforcement learning configuration collected by at least one of an artificial intelligence data source management entity, an artificial intelligence training management entity, and an artificial intelligence inference management entity.

87. The apparatus according to claim 82, wherein
the at least one processor, with the at least one memory and the computer program code, being configured to cause the apparatus to perform:
transmitting said reinforcement learning configuration to at least one of an artificial intelligence data source management entity, an artificial intelligence training management entity, and an artificial intelligence inference management entity, and
receiving metrics in accordance with said reinforcement learning configuration from at least one of said artificial intelligence data source management entity, said artificial intelligence training management entity, and said artificial intelligence inference management entity.

88. The apparatus according to claim 85, wherein
the at least one processor, with the at least one memory and the computer program code, being configured to cause the apparatus to perform:
verifying a level of safety of said reinforcement learning based on said metrics.

89. The apparatus according to claim 88, wherein
the at least one processor, with the at least one memory and the computer program code, being configured to cause the apparatus to perform:
modifying said final reinforcement learning plan based on said level of safety of said reinforcement learning.

90. An apparatus comprising
at least one processor,
at least one memory including computer program code, and
at least one interface configured for communication with at least another apparatus,
the at least one processor, with the at least one memory and the computer program code, being configured to cause the apparatus to perform:
receiving a reinforcement learning configuration,
receiving a final reinforcement learning plan,
transmitting said reinforcement learning configuration to at least one of an artificial intelligence data source management entity, an artificial intelligence training management entity, and an artificial intelligence inference management entity, and
receiving metrics in accordance with said reinforcement learning configuration from at least one of said artificial intelligence data source management entity, said artificial intelligence training management entity, and said artificial intelligence inference management entity.

91. The apparatus according to claim 90, wherein
said reinforcement learning configuration includes a reinforcement learning monitoring configuration comprising at least one of information on parameters to be monitored, information on parameters to be reported, and information on a measurement period.

92. The apparatus according to claim 90, wherein
said reinforcement learning configuration includes a reinforcement learning trustworthiness configuration comprising at least one of a reinforcement learning model explainability configuration, a reinforcement learning model fairness configuration, and a reinforcement learning model robustness configuration.

93. The apparatus according to claim 90, wherein
said final reinforcement learning plan includes at least one of a list of actions allowed to be executed for reinforcement learning, information on an expected impact of application of said final reinforcement learning plan on a network corresponding to said network scenario, information on an expected time interval of said expected impact, and information on measures to be taken upon exceedance of said expected impact and/or said expected time interval of said expected impact.

94. The apparatus according to claim 93, wherein
said list of actions allowed to be executed for said reinforcement learning includes at least one action, wherein
each of said at least one action is defined by at least one of information on one or more parameters to be changed by said action, information on one or more allowable change ranges corresponding to said one or more parameters to be changed by said action, information on one or more action targets, information on an action execution time, information on an action execution frequency, information on an action application realm, information on an expected impact of application of said action on said network, information on an expected time interval of said expected impact, and information on measures to be taken upon exceedance of said expected impact and/or said expected time interval of said expected impact.

95. An apparatus comprising
at least one processor,
at least one memory including computer program code, and
at least one interface configured for communication with at least another apparatus,
the at least one processor, with the at least one memory and the computer program code, being configured to cause the apparatus to perform:
receiving a final reinforcement learning plan,
deciding on a degree of implementation of said final reinforcement learning plan, and
implementing said final reinforcement learning plan based on said decided degree of implementation.

96. The apparatus according to claim 95, wherein
said deciding is based on current network conditions.

97. The apparatus according to claim 95, wherein
the at least one processor, with the at least one memory and the computer program code, being configured to cause the apparatus to perform:
transmitting information on said degree of implementation.

98. The apparatus according to claim 95, wherein
said final reinforcement learning plan includes at least one of a list of actions allowed to be executed for reinforcement learning, information on an expected impact of application of said final reinforcement learning plan on a network corresponding to said network scenario, information on an expected time interval of said expected impact, and information on measures to be taken upon exceedance of said expected impact and/or said expected time interval of said expected impact.

99. The apparatus according to claim 98, wherein
said list of actions allowed to be executed for said reinforcement learning includes at least one action, wherein
each of said at least one action is defined by at least one of information on one or more parameters to be changed by said action, information on one or more allowable change ranges corresponding to said one or more parameters to be changed by said action, information on one or more action targets, information on an action execution time, information on an action execution frequency, information on an action application realm, information on an expected impact of application of said action on said network, information on an expected time interval of said expected impact, and information on measures to be taken upon exceedance of said expected impact and/or said expected time interval of said expected impact.
